(19) United States
(12) Patent Application Publication
(10) Pub. No.: US 2012/0127175 A1
(43) Pub. Date: May 24, 2012

(54) METHODS AND SYSTEMS FOR SELECTING OBJECT COVERING MODEL FRAGMENTS

(75) Inventor: Gershon ELBER, Haifa (IL)

(73) Assignee: Technion Research & Development Foundation Ltd., Haifa (IL)

(21) Appl. No.: 13/298,331

(22) Filed: Nov. 17, 2011

Related U.S. Application Data
(60) Provisional application No. 61/415,107, filed on Nov. 18, 2010.

(51) Int. Cl. G06T 17/00

(52) U.S. Cl. 345/420

(57) ABSTRACT

A computerized method of mapping a plurality of model fragments covering a selected object. The method comprises receiving a representation of an object, generating a parameterized data model of the object according to said representation, the parameterized data model having a plurality of elements, setting a plurality of model fragments each cover a portion of the parameterized data model, applying, using a processor, a set cover algorithm to identify a subgroup of the plurality of model fragments so that a union of a plurality of members of the subgroup covers said parameterized data model, and outputting the subgroup.

### RELATED APPLICATION

This application claims the benefit of priority under 35 USC 119(e) of U.S. Provisional Patent Application No. 61/415,107 filed Nov. 18, 2010, the contents of which are incorporated herein by reference in their entirety.

### FIELD AND BACKGROUND OF THE INVENTION

The present invention, in some embodiments thereof, relates to object coverage identification and, more particularly, but not exclusively, to methods and systems for fragmenting said object.

Geometric covering is a classical research area in computational geometry, in which problems are instances induced by geometric settings of the well-known set-cover problem. In such problems, one has to “cover” geometric objects with other geometric objects. That is, the latter collection of geometric objects should contain the former. Geometric covering problems have been studied extensively. These problems are instances induced by geometric settings of the well-known set-cover problem. The set-cover problem is a classical problem in computer science. Given a collection S={A₁, . . . , Aₙ} of subsets of a universal set U, and a set Y⊂U of size n that is to be covered, the goal is to determine a minimum-cardinality (or minimum-weight) sub-collection S*⊂S such that U_{A}_{ᵢ}_{∈S}·Aᵢ⊃Y.

### SUMMARY OF THE INVENTION

According to some embodiments of the present invention, there is provided a computerized method of mapping a plurality of model fragments covering a selected object. The method comprises receiving a representation of an object, generating a parameterized data model of the object according to the representation, the parameterized data model having a plurality of elements, setting a plurality of model fragments each cover a portion of the parameterized data model, applying, using a processor, a set cover algorithm to identify a subgroup of the plurality of model fragments so that a union of a plurality of members of the subgroup covers the parameterized data model, and outputting the subgroup.

Optionally, the applying comprises applying the set cover algorithm to identify the subgroup of the plurality of model fragments so that each the element is covered by at least K of the plurality of members wherein the K is greater than 1 constant.

Optionally, the generating comprises automatically identifying at least one of a shape, a type, and a number of dimensions of the object and generating the parameterized data model accordingly.

Optionally, the parameterized data model is spatial and the object having at least three dimensions.

Optionally, the plurality of model fragments are indicative of a simulation of a plurality of fields of view of locations of reference of view of a plurality of cameras located in or around the object.

Optionally, the plurality of model fragments are indicative of a simulation of a plurality of areas illuminated by a plurality of illumination means located in or around the object.

Optionally, the plurality of model fragments are indicative of a simulation of a plurality of moldable segments of a mold of the object.

Optionally, the plurality of model fragments are indicative of a simulation of a plurality of reception areas of a plurality of antennas located in or around the object.

Optionally, the subgroup is a minimum subgroup of the plurality of model fragments which a union of its plurality of members covers the parameterized data model.

Optionally, the parameterized data model is defined in a multidimensional discrete grid, each the plurality of element being assigned to another of a plurality of slots of the grid.

Optionally, the applying comprises applying the set cover algorithm to identify the subgroup so that respective at least K of the plurality of model fragments cover each the element; wherein the K is greater than 1 constant.

Optionally, the plurality of elements comprises a plurality of voxels.

Optionally, the plurality of elements comprises a plurality of pixels.

According to some embodiments of the present invention, there is provided a system of mapping a plurality of model fragments of a selected object. The system comprises a processor, an input unit which receives a representation of an object, a parameterization module which generates a parameterized data model of the object according to the representation, the parameterized data model having a plurality of elements, a fragmentation module which calculates a plurality of model fragments each cover a portion of the parameterized data model, a cover set module which applies, using the processor, a set cover algorithm to identify a subgroup of the plurality of model fragments so that a union of a plurality of members of the subgroup covers the parameterized data model, and an output unit which outputs the subgroup.

According to some embodiments of the present invention, there is provided a computer program product, comprising a computer usable medium having a computer readable program code embodied therein, the computer readable program code adapted to be executed to implement a method of mapping a plurality of model fragments of a selected object, the method comprising, receiving a representation of an object, generating a parameterized data model of the object according to the representation, the parameterized data model having a plurality of elements, setting a plurality of model fragments each cover a portion of the parameterized data model, applying a set cover algorithm to identify a subgroup of the plurality of model fragments so that a union of a plurality of members of the subgroup covers the parameterized data model, and outputting the subgroup.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of a method of identifying a subgroup, optionally minimal, of a group of model fragments which a union thereof covers a parameterized data model representing an object, according to some embodiments of the present invention;

FIG. 2 is a relational view of software components of a system for identifying a subgroup from a group of fragments wherein the subgroup covers a parameterized data model representing an object, according to one embodiment of the invention;

FIG. 3 is a schematic illustration of the Utah teapot model rendered from three different view locations along with the UV parametric spaces' UV maps, creating three different model fragments, according to one embodiment of the invention; and

FIG. 4 is a schematic illustration of six different views in Euclidean space (left) and the union of the six parametric spaces' UV maps (right), according to one embodiment of the invention.

### DESCRIPTION OF EMBODIMENTS OF THE INVENTION

The present invention, in some embodiments thereof, relates to object coverage identification and, more particularly, but not exclusively, to a methods and systems for fragmenting said object.

According to some embodiments of the present invention, there are provided methods and systems of identifying a subgroup, optionally minimal, from a group of model fragments, which covers a parameterized data model of an object of any of various types, for example a terrain, a volume, a spatial object, a spatial object which change over time, also referred to as a four dimension (4D) object, and/or the like. The model fragments may be simulations of moldable segments of a mold of the object, areas illuminated by illumination means which are placed in or around the object, wireless connectivity areas of different antennas which are placed in or around the object, areas guarded by guards which are placed in stands in or around the object, areas monitored by cameras which are placed in camera stands in or around the object, and/or the like. In such embodiments, the methods and systems may be used for identifying optimal coverage in architectural design, communication network design, a security network design, mold design and/or the like.

For example, according to some embodiments of the present invention, a method of mapping a plurality of model fragments covering a selected object is provided. Each model fragment may represent an area or a volume which is associate with a location of reference in or around the object, for example stand and/or angle of an illumination means, a camera, an antenna and/or the like. Hereafter, a location of reference may also be a point where an antenna is placed, a line or a curve along which a guard is patrolling, a line along which the camera can move, and/or the like. The method is based on a representation of an object which may be selected manually by a user or automatically computing unit. First, a parameterized data model of the object is generated according to the representation where the parameterized data model optionally has a plurality of elements, such as voxel, pixels, and/or the like. This allows setting a plurality of model fragments, each cover a portion of the parameterized data model, either continuously or noncontinuously. Now, a set cover algorithm is applied to identify a subgroup of the plurality of model fragments so that a union of a plurality of members of the subgroup covers said parameterized data model. The subgroup is optionally a minimal subgroup. Then the subgroup is outputted, for example presented to a user and/or sent as a dataset for a processing function of a design platform.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

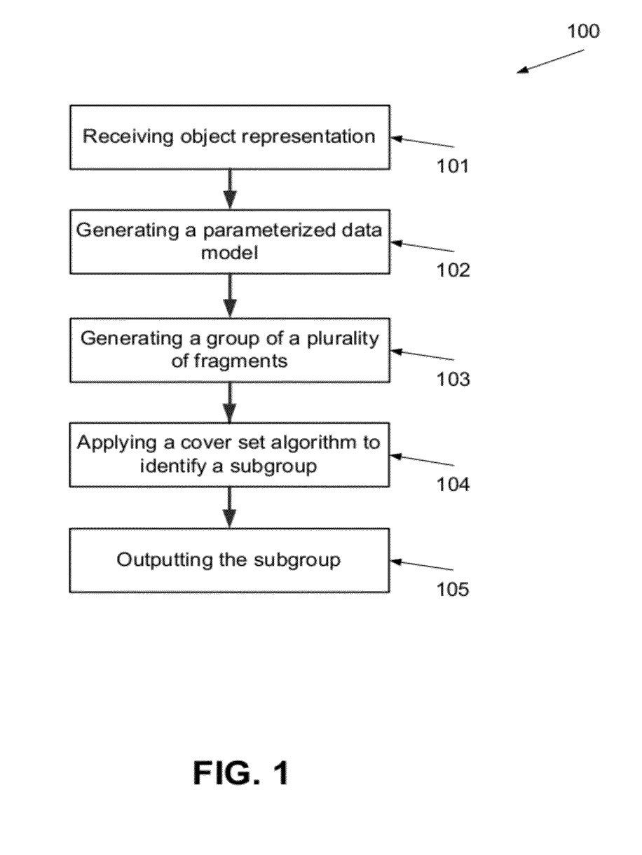

Reference is now made to FIG. 1, which is a flowchart of a method 100 of identifying a subgroup, optionally minimal, of a group of continuous and/or non continuous model fragments which a union thereof covers a parameterized data model representing an object, such as an area or a space, according to some embodiments of the present invention. The method 100 may be implemented by one or more software and/or hardware modules of a computing unit, such as a laptop, a desktop, a tablet, a server, a network node, and/or the like. For example, the module may be executed as part of a design platform which receives as an input an object and outputs a subgroup of model fragments which a union thereof covers a parameterized data model generated according to present the object. This process may be used for in a number of applications.

For example, the module may be a mold design application which receives a spatial outline of an object to be molded and the output is a division of the object into a set, optionally minimal, of 3D model fragments each defining a valid moldable part which may be disassembled.

In another example, the module may be an architectural design application, for example for designing roads, sport fields, and/or any other illuminated. This application receives an outline of a planned space and/or an existing space and the output is a division of the space into a set, optionally minimal, of 3D model fragments each represents an illumination zone of an illumination means in a certain illumination stand, position, angle and/or the like. In architectural design, optimal placement of illumination means, such as lamps, ensures proper illumination coverage at a minimal or low cost.

In another example, the module may be a security design application, for example for designing the placement of security cameras and/or guards stands. This application receives an outline of a planned space and/or an existing space and the output is a division of the space into a set, optionally minimal, of model fragments each represents a field of view of a camera or a guard following a certain path and/or the like. In security design, optimal placement of guards means ensuring proper coverage at a minimal or low cost.

In another example, the module may be a communication infrastructure design application, for example for designing cellular and/or a wireless local area network (WLAN) communication network infrastructure and/or any other communication area. This application receives an outline of a planned space and/or an existing space and the output is a division of the space into a set, optionally minimal, of model fragments each represents a coverage area of an antenna and/or the like. In communication infrastructure applications, optimal placement of antennas ensures a required level of connectivity at a minimal or low cost, for example with minimal numbers of antennas.

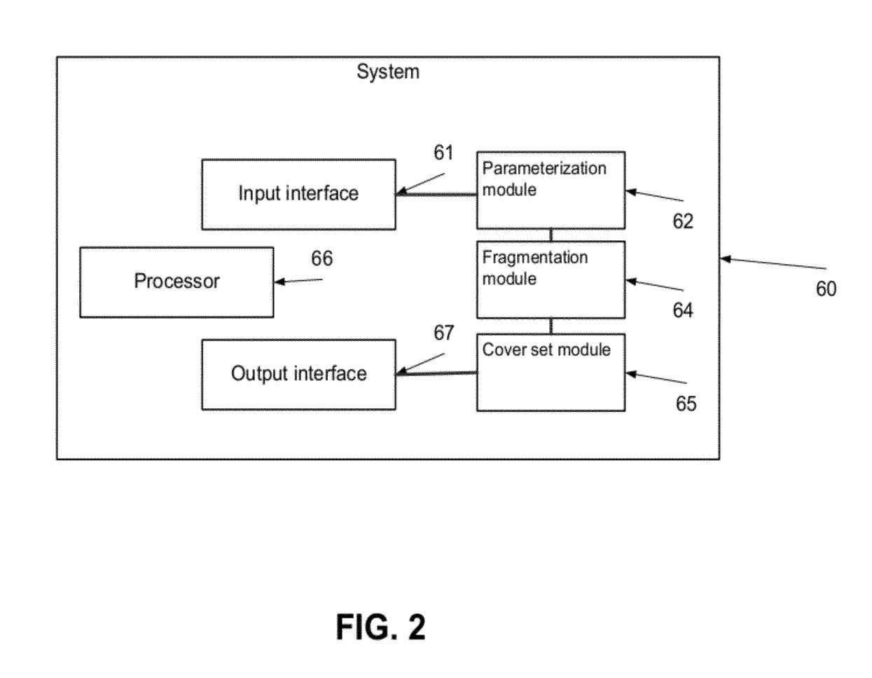

Reference is also made to FIG. 2 which illustrates a relational view of software components of a system 60 having a processor 66 for identifying a subgroup, optionally minimal, from a group of fragments wherein the subgroup covers a parameterized data model representing the object, according to one embodiment of the invention. The system may be implemented on any or using any of various computing units, such as a desktop, a laptop, a network node, such as a server, a tablet, and/or the like. As shown, software components include an input interface 61 which receive a representation of an object, for example according to user selection in a user interface, optionally from a file and/or a screen. The system 60 further includes a parameterization module 62 for generating a parameterized model of the object, for example as described below. The system 60 further includes, a fragmentation module 64 for calculating a plurality of fragments, for example as described below, and a cover set module 65, which identify a subgroup of fragments according to a cover set algorithm, for example as described below. The lines in FIG. 2 depict optional and non limiting data flow between the modules. The system 60 further includes an output module 67 for outputting said subgroup, for example to a presentation unit which presents the subgroup, for example either graphically or textually, to a user on a display of which is connected to the system.

First, as shown at 101, data indicative of an object is received. For example, an image, a three dimensional scan, architectural design, and/or any other media, such as a file, which includes a representation of an object, for example existing and/or planned space, one or more existing and/or planned structure(s), one or more existing and/or planned element(s), and/or the like is received. The representation is optionally received and/or generated by any of the aforementioned modules.

Now, as shown at 102, a parameterized data model of the object is generated. Optionally, the type of the object is identified automatically, for example by an analysis of its shape, area, and/or volume. The analysis is optionally based on the object representation. This allows matching a suitable parameterization function. In such a manner, the parameterization is adapted, for example automatically, to the type of the object and/or to different regions of the object:
1. Surfaces and curves—the inherent parametric representation of surfaces and curves may be used for creating parametric surfaces or curves. For example, a polygonal mesh with no parameterization is found and known algorithms are used to create such a parameterization in the plane, see for example M. S. Floater and K. Hormann. “Surface parameterization: a tutorial and survey”, in Advances in Multi-resolution for Geometric Modeling, 2005, pp 157-186, Springer, and G. Elber, R. Sayegh, G. Barequet, and R. R. Martin. “Two-Dimensional Visibility Charts for Continuous Curves.” Shape Modeling International OS, Boston, USA, June 2005, MJT, Boston, USA, pp 206-215 June 2005, which are incorporated herein by reference. For surfaces and/or polygonal meshes in three dimensions, the parameterization typically used for texture mapping could be exploited here as well.
2. Roads and trails—parameterization may be performed by a first parameter set along a center line and a second parameter which defines the width of the road and/or trail as an offset from the center line.
3. Two dimensional (2D) terrains—for a general terrain, such as a football field, an air field, and/or a demilitarized zone, project onto Z=0 plane to create a parameterization using the resulting XY coordinates. Alternatively, the terrain maybe represented as a general polygonal mesh where parameterization is reconstructed accordingly.
4. 3D volumes—for an object to be monitored, for example a space, a view point of a camera maybe in the air, parameterize a 3D space according to the parameterization of the underneath terrain, for example by two parameters and an estimated height, for example using an additional parameter.

As shown at 103, after the parameterized data model is generated, a group that includes a plurality of model fragments is calculated. Each model fragment covers a portion of the parameterized data model. Some of the portions may overlap while others may contain other portions.

Optionally, model fragmentation information which defines how the parameterized data model may be fragmented with reference to locations of reference in or around the object, such as points of view, points of transmission, paths of patrol and/or the like, is computed. For example, model fragments may represent visible area(s) which associated with different locations of reference. In another example, each one of the model fragments represents area(s) accessible to a guard is associated with a certain guard stand or patrol paths. In another example, each model fragment represents illuminated area(s) which are illuminated by illumination means of a certain type and associated with a certain illumination means place and angle. In another example, each one of the model fragments represents illuminated area(s) which are illuminated by illumination means of a certain type and associated with a certain illumination means stand.

Optionally, a brute-force scheme is used for inspecting the object to extract the respective model fragments in association with different locations of reference.

Optionally, in order to reduce the computational complexity of the calculation of the model fragments, viewing space may be measured in a desired density. This approach reduces complexity at the cost of being non optimal. Yet, the denser the sampling is the more accurate the expected result will be, at the cost of more computations.

Optionally, in order to reduce the computational complexity of calculating the model fragments, equivalent classes are detected in the object and a limited number of views, for example one, from each equivalent class is sampled. For example, two points of views are in the same equivalent class if they both cover the same model fragment of the model. Clearly, neighboring views are likely to belong to the same equivalent class.

Optionally, in order to reduce the computational complexity of calculating the model fragments, locations of reference and respective model fragments are selected according to their importance. For example, model fragments of a model that has a narrow tunnel passing therethrough, which are related to points of view which cover internal space of the tunnel, are highly ranked.

It should be noted that as the inspected regions of the object are parameterized, every model fragment which may be viewed from every location of reference may be represented as a binary map in the parametric domain, for example an outcome of a function. For example, in the binary map some elements are marked as visible and/or accessible and some are marked as invisible and/or inaccessible. In practice, a parameterized data model may be used to represent discretely any multidimensional object in a parametric domain.

Optionally, a binary map image of a fragment, regardless of the number of dimensions, is reduced into a linear vector of bits, for example by scanning one row of the image after another in a multidimensional image, for example 2D, 3D, and/or four dimensions (4D) images. In such an embodiment, the parameterization creates a set of sequences of images, linearized into vectors. The images are optionally bitmaps where 0/1 is indicative of visibility/invisibility.

Optionally, the set cover algorithm is automatically applied to identify a subgroup of the group of model fragments so that each member of the union of members of the subgroup overlaps with one or more other members the of the subgroup to provide a double, triple, quadruple, and/or the like cover to each element of the parameterized data model. In such a manner, each area may be imaged by a plurality of cameras, illuminated by a plurality of illumination means, provide wireless communication via more than one antenna and/or the like.

According to some embodiments of the present invention, each model fragment defines nonuniform values, which are indicative of different levels of coverage of sub model fragments of the model fragment. For example, each model fragment may be represented as a gray-level image wherein each gray level value is indicative of level of coverage in a certain voxel and/or pixel of the model fragment and hence the parameterized data model. For example, a gray level value represents illumination intensity when the model fragment represents illumination area of a lamp at a certain location of reference. The gray level values may be calculated according to the assumption that illumination intensity in a certain illuminated area is proportional to the square of the distance from the illumination source. In another example, a gray level value represents reception quality when the model fragment represents reception area of an antenna at a certain location of reference. The gray level values may be calculated according to the assumption that the transmission level of antennas is continuously decaying with the distance and/or according to the effect of existing obstacles. Hence, a proper coverage for the placement of antennas could also greatly benefit from the support of a continuous coverage via gray-level images. Optionally, coverage would be considered valid if the gray level value is above a threshold.

Now, as shown at 104, a set cover algorithm is automatically applied to identify a subgroup of the group of model fragments so that a union of a plurality of members of the subgroup covers the parameterized data model. The subgroup includes as less members as possible (minimal group).

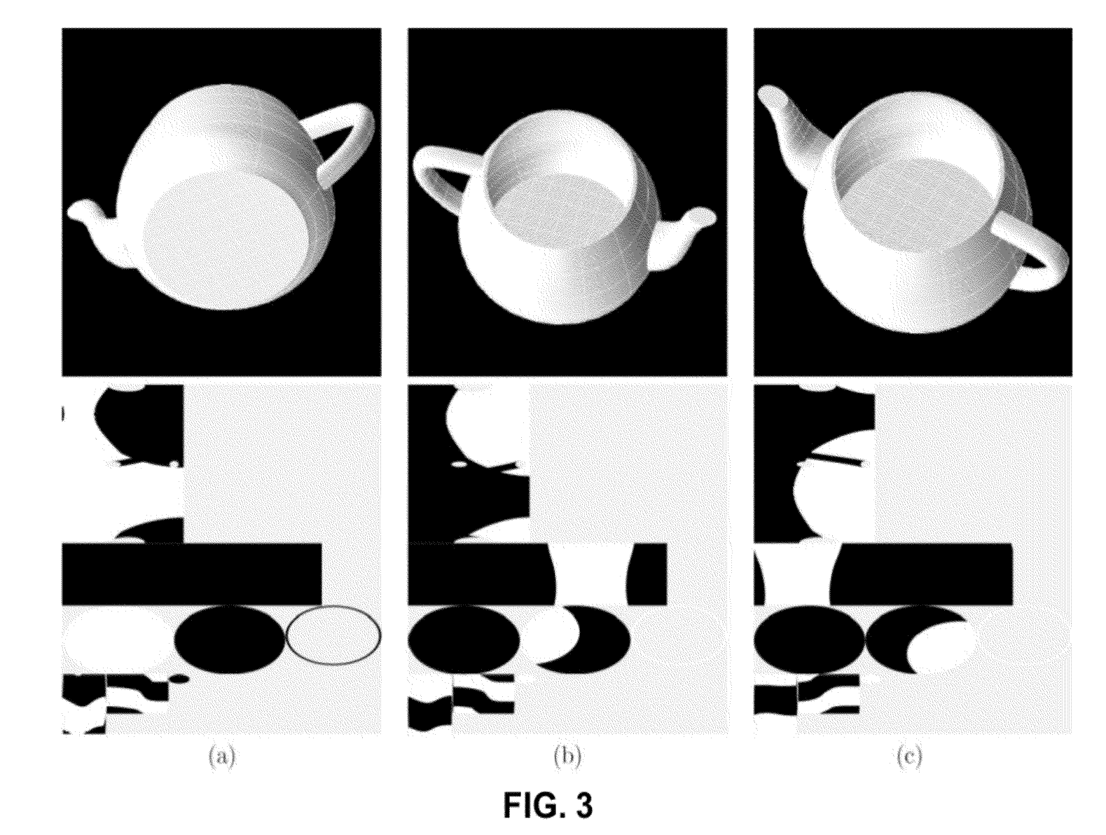

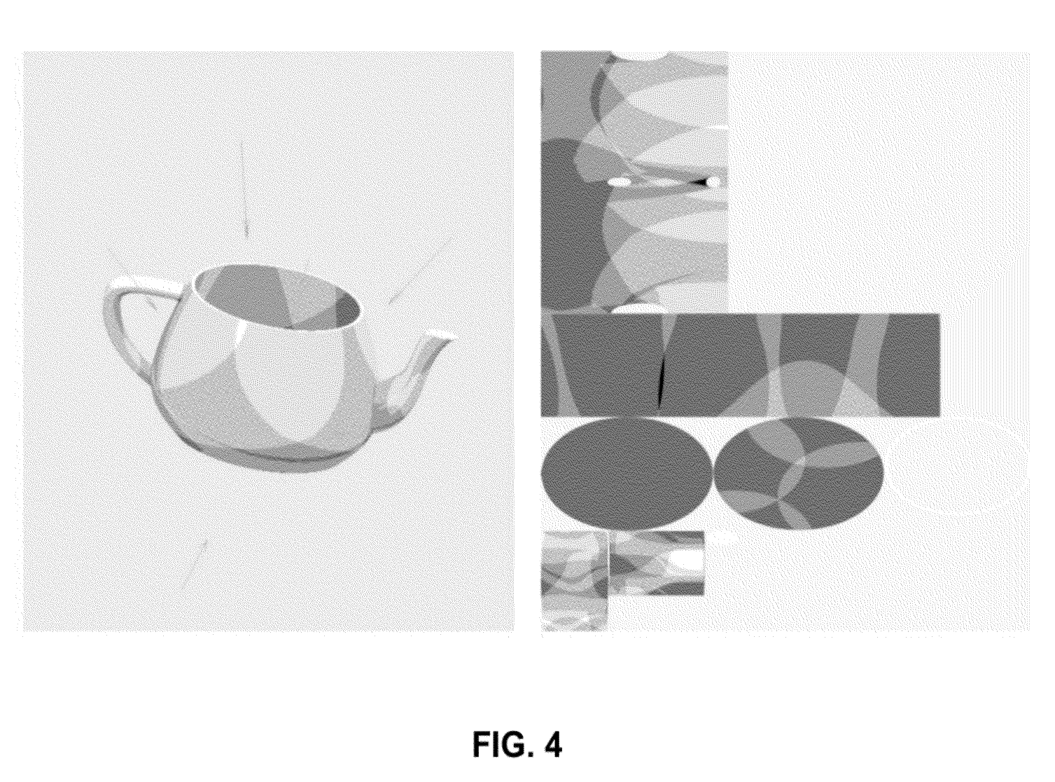

Optionally, the model elements are set as triangles. Every triangle, in addition to its XYZ Euclidean coordinates, also has three (u, v) coordinates that defines the triangle's vertexes in the UV parametric domain. Optionally, a Z-buffer depth algorithm is used to estimate the visibility of each object element covered, by each triangle, in two passes. First, a regular Z-buffer scan-conversion hidden-surface removal is applied in Euclidean space from a certain view point to the model and result is saved. Then, as is shown in FIG. 3, every triangle is scan-converted again in parametric space and for each (interpolated) UV and XYZ location in the triangle, the Z value is compared against the depth in the Z-buffer of the first pass, at the designated XY location, deciding if it is hidden or visible. As a result, we now have a parametric space UV map of visible and hidden locations. FIG. 3 depicts the Utah teapot model rendered from three different view locations along with the UV parametric spaces' UV maps, creating three different model fragments. Every pixel in the UV map is either black (invisible) or white (visible) or “don't care” (yellow) meaning this UV pixel has no counterpart in Euclidean XYZ space. A set cover algorithm applied to the set of model fragments selects the optimal covering and as depicted in FIG. 4, six selected view locations yield a covering of over 99%. FIG. 4 depicts six different views in Euclidean space (left) and the union of the six parametric spaces' UV maps (right), where the brighter the gray-level is, the larger is the covering of that pixel.

If the model fragments are illuminated areas and a minimal subgroup is sought for, for every element, for example pixel in a parametric scan conversion, the distances between the illumination source and the illuminated locations is measured and rays (i.e. ray tracing) are set to calculate all light sources in the scene and based on their intensity, distance and/or visibility, a set of model fragments and/or illumination source stands that illuminate this set of model fragments and provide proper illumination (per unit area) is selected. In communication infrastructure applications where transmission level is estimated, the integration of the obstructions a ray from the potential antenna position to the examined location(s) accumulates, based on the different materials it traverses, could be used to create a transmission level map for any antennas' location.

Optionally, each model fragment may be represented as a single image (defined over the parameterization of the input geometry) per location of reference. The image can originate from an 1D input, for example by inspecting a curve as is performed in G. Elber, R. Sayegh, G. Barequet, and R. R. Martin. “Two-Dimensional Visibility Charts for Continuous Curves.” Shape Modeling International OS, Boston, USA, June 2005, MJT, Boston, USA, pp 206-215 June 2005, which is incorporated herein by reference.

As described above, an image may be a bitmap where black and white designates visible or hidden elements, or gray level image that represents intensities of illumination and/or the like. Optionally, the result is sequenced into a linear vector of bits or bytes, to be fed into a minimum covering set solver that applies the set cover algorithm.

Now, as shown at 104, the identified subgroup is outputted.

Reference is now made to an exemplary algorithm for identifying a subgroup of model fragments which cover an inputted object:

Algorithm 1:
Input: O: an nD object (i.e. a scene, a region to inspect using a minimal set of locations of reference, for example illumination means locations, camera views, guard paths of patrol, and/or antenna locations)
Output: A finite set of model fragments, for example covering the parameterized data model of the object.

Algorithm:
1. Derive a parameterization to domain of O.
2. Ω<=A discrete set of a number of fragments of the parameterized model of domain of O, for example a number of locations to consider examining O from;
3. For each fragment/view v ∈ Ω do
   Compute a sub domain of domain O that is visible/invisible in nD and return as an image, optionally sequenced into a vector;
4. Derive a subgroup of the discrete set, for example a minimal covering set of the result of step 3.

While step 4 of Algorithm 1 is exponential in the general setting, a discrete subgroup may be identified if it is known to be limited to a small number of fragments or locations of reference. Moreover, some additional local optimizations could be applied to the above process. For instance, model fragments defined as visibility/invisibility maps are likely to be similar for proximate points of view.

Optionally, all n input model fragments defined as visibility maps are examined (=images) to define the i^{th} word of length n to be the chain of the i^{th} bits in all images. Clearly, the chances for word i and word i+1 to be equal are not slim at all, as they represent neighboring locations inspected from the same set of points of view. Hence, one may shrink and eliminate portions of the images that possess identical words, keeping just one instance of each such equivalence class.

It is expected that during the life of a patent maturing from this application many relevant systems and methods will be developed and the scope of the term a computing unit is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, an and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A computerized method of mapping a plurality of model fragments covering a selected object, comprising:
receiving a representation of an object;
generating a parameterized data model of said object according to said representation, said parameterized data model having a plurality of elements;
setting a plurality of model fragments each cover a portion of said parameterized data model;
applying, using a processor, a set cover algorithm to identify a subgroup of said plurality of model fragments so that a union of a plurality of members of said subgroup covers said parameterized data model; and
outputting said subgroup.

2. The method of claim 1, wherein said applying comprises applying said set cover algorithm to identify said subgroup of said plurality of model fragments so that each said element is covered by at least K of said plurality of members wherein said K is greater than 1 constant.

3. The method of claim 1, wherein said generating comprises automatically identifying at least one of a shape, a type, and a number of dimensions of said object and generating said parameterized data model accordingly.

4. The method of claim 1, wherein said parameterized data model is spatial and said object having at least three dimensions.

5. The method of claim 1, wherein said plurality of model fragments are indicative of a simulation of a plurality of fields of view of locations of reference of view of a plurality of cameras located in or around said object.

6. The method of claim 1, wherein said plurality of model fragments are indicative of a simulation of a plurality of areas illuminated by a plurality of illumination means located in or around said object.

7. The method of claim 1, wherein said plurality of model fragments are indicative of a simulation of a plurality of moldable segments of a mold of said object.

8. The method of claim 1, wherein said plurality of model fragments are indicative of a simulation of a plurality of reception areas of a plurality of antennas located in or around said object.

9. The method of claim 1, wherein said subgroup is a minimum subgroup of said plurality of model fragments which a union of its plurality of members covers said parameterized data model.

10. The method of claim 1, wherein said parameterized data model is defined in a multidimensional discrete grid, each said plurality of element being assigned to another of a plurality of slots of said grid.

11. The method of claim 1, wherein said applying comprises applying said set cover algorithm to identify said subgroup so that respective at least K of said plurality of model fragments cover each said element; wherein said K is greater than 1 constant.

12. The method of claim 1, wherein said plurality of elements comprises a plurality of voxels.

13. The method of claim 1, wherein said plurality of elements comprises a plurality of pixels.

14. A computer readable medium comprising computer executable instructions adapted to perform the method of claim 1.

15. A system of mapping a plurality of model fragments of a selected object, comprising:
a processor;
an input unit which receives a representation of an object;
a parameterization module which generates a parameterized data model of said object according to said representation, said parameterized data model having a plurality of elements;
a fragmentation module which calculates a plurality of model fragments each cover a portion of said parameterized data model;
a cover set module which applies, using said processor, a set cover algorithm to identify a subgroup of said plurality of model fragments so that a union of a plurality of members of said subgroup covers said parameterized data model; and
an output unit which outputs said subgroup.

16. A computer program product, comprising a computer usable medium having a computer readable program code embodied therein, said computer readable program code adapted to be executed to implement a method of mapping a plurality of model fragments of a selected object, said method comprising:
receiving a representation of an object;
generating a parameterized data model of said object according to said representation, said parameterized data model having a plurality of elements;
setting a plurality of model fragments each cover a portion of said parameterized data model;
applying a set cover algorithm to identify a subgroup of said plurality of model fragments so that a union of a plurality of members of said subgroup covers said parameterized data model; and
outputting said subgroup.
